(19) United States
(12) Patent Application Publication
(10) Pub. No.: US 2025/0116205 A1
(43) Pub. Date: Apr. 10, 2025

(54) NOZZLE FOR FOAM WASHING OF JET ENGINE

(71) Applicant: AeroCore Technologies LLC, Lebanon, IN (US)

(72) Inventor: Jorge Ivan Saenz, Zionsvilie, IN (US)

(73) Assignee: AeroCore Technologies LLC, Lebanon, IN (US)

(21) Appl. No.: 18/982,703

(22) Filed: Dec. 16, 2024

Related U.S. Application Data
(63) Continuation of application No. 16/937,522, filed on Jul. 23, 2020, now abandoned.
Application No. 16/937,522 is a continuation of application No. 14/985,940, filed on Dec. 31, 2015, now abandoned.
(60) Provisional application No. 62/098,664, filed on Dec. 31, 2014.

(51) Int. Cl. F01D 25/00; B08B 3/00; F04D 29/70

(52) U.S. Cl. CPC F01D 25/002; B08B 3/003; F04D 29/705; F05D 2220/32; F05D 2230/72; F05D 2260/607; F05D 2300/612; Y02T 50/60

(57) ABSTRACT

Turbines and associated equipment are normally cleaned via water or chemical pressure washing via a mist, spray systems. However, these systems fail to reach deep across the gas path to remove fouling materials. Various embodiments herein pertain to apparatus and methods that utilize the water and existing chemicals to generate a foam. The foam can be introduced at that gas-path entrance of the equipment, where it contacts the stages and internal surfaces, to contact, scrub, carry, and remove fouling away from equipment to restore performance. Various embodiments pertain to spout assemblies for providing foam to the compressor of commercial fan engines, and in yet other embodiments to engines receiving air from a long inlet duct, especially those having a serpentine inlet ducts.

### CROSS REFERENCE TO RELATED APPLICATION

This application is a continuation of U.S. patent application Ser. No. 16/937,522, filed Jul. 23, 2020, which is a continuation of U.S. patent application Ser. No. 14/985,940, filed Dec. 31, 2015, now abandoned, which claims the benefit of priority to U.S. Provisional Patent Application No. 62/098,664, filed Dec. 31, 2014, all of which are incorporated herein by reference.

### FIELD OF THE INVENTION

Various embodiments of the present invention pertain to apparatus and methods for cleaning a gas path, especially a gas path including a combustion chamber, and in particular to apparatus and methods for cleaning of a gas turbine engine.

### BACKGROUND

Turbine engines extract energy to supply power across a wide range of platforms. Energy can range from steam to fuel combustion. Extracted power is then utilized for electricity, propulsion, or general power. Turbines work by turning the flow of fluids and gases into usable energy to power helicopters, airplanes, tanks, power plants, ships, specialty vehicles, cities, etc. Upon use, the gas-path of such devices becomes fouled with debris and contaminants such as minerals, sand, dust, soot, carbon, etc. When fouled, the performance of the equipment deteriorates, requiring maintenance and cleaning.

It is well known that turbines come in many forms such as jet engines, industrial turbines, or ground-based and ship-based aero-derived units. The internal surfaces of the equipment, such as that of an airplane or helicopter engine, accumulate fouling material, deteriorating airflow across the engine, and diminishing performance. Correlated to this trend, fuel consumption increases, engine life shortens, and power available decreases. The simplest means and most cost effective means to maintain engine health and restore performance are to properly clean an engine. There are many methods available, such as mist, sprays, and vapor systems. However, all fail to reach deep or across the entire engine gas-path. Further, telemetry or diagnostic tools on engine have become routine functions to monitor engine health. Yet, using such tools to monitor, trigger, or quantify improvement from foam engine cleaning need to be utilized. Various embodiments of the present invention provide novel and unobvious methods and apparatus for the injecting chemical cleaning agents into of such power plants.

### SUMMARY OF THE INVENTION

In one embodiment, foam material is introduced at the gas-path entry of turbine equipment while off-line. The foam coats and contacts the internal surfaces, scrubbing, removing, and carrying fouling material away from equipment. The effluent is collected for post processing and various other embodiments of the present invention apply the use of diagnostic tools to enhance the utility of the present invention.

One aspect of the present invention pertain to a system for providing an air-foamed liquid cleaning agent. Some embodiments include an air pump providing air at pressure higher than ambient pressure, and a liquid pump providing the liquid cleaner at pressure. Yet other embodiments include a nucleation device receiving air from the air pump, and liquid from the liquid pump, and creating a foam having a structure. Still other embodiments include a spout assembly in an approximate J-shape and including a foam inlet linearly spaced apart from a hooked end having a foam exit the nozzle being adapted and configured to deliver a stream of foam at a velocity of less than about twenty feet per second.

Another aspect of the present invention pertains to a method for providing an air-foamed water soluble liquid cleaning agent to a jet engine having a bypass duct. Some embodiments include providing a source of liquid cleaning agent, a turbulent mixing chamber, and a spout assembly having a non-atomizing delivery nozzle. Yet other embodiments include mixing air with liquid in the mixing chamber and creating a supply of foam.

Yet further aspects of the present invention pertain to a method for providing a foamed liquid cleaning agent to a jet engine receiving air from a serpentine inlet duct. Such ducts have become common on some military aircraft in order to prevent line of site viewing of the engine front face. Some such ducts include bends in a lateral direction (such as inboard) as well as a vertical direction (upward) to provide air to a buried engine. Some embodiments include spout assemblies adapted and configured with a receptacle on the distalmost end of the spout assembly that positively locates the distalmost end on a specific feature of the engine, inlet, or aircraft. Having such a receptacle, a subsequent coupling of that receptacle to an engine feature permits maintenance personnel to have positive verification that the spout assembly is correctly located in the duct.

It will be appreciated that the various apparatus and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

Some of the figures shown herein may include dimensions. Further, some of the figures shown herein may have been created from scaled drawings or from photographs that are scalable. It is understood that such dimensions, or the relative scaling within a figure, are by way of example, and not to be construed as limiting.

FIG. 1A is a graphical representation of a section view of a large aircraft turbofan engine being cleaned with a system according to one embodiment of the present invention.

FIG. 1B is a schematic representation of a foam delivery system according to one embodiment of the present invention.

FIG. 2A is a graphical representation of the spout placement as represented on the cross-section view of a large aircraft engine.

FIG. 2B is a close up view a graphical representation of the spout placement to inject cleaning product as desired into the compressor section of the aircraft engine.

FIG. 2C is a graphical perspective angle-view of a side-cross-section and front view of and aircraft engine of FIG. 2A.

FIG. 3A is in similar perspective to FIG. 2C but with the fan section and inlet cone removed.

FIG. 3B is a graphical representation of the spout fastened to engine structural struts.

FIG. 4 is a drawing of multiple embodiments V.1, V.2, and V.3 of inventive apparatus.

FIG. 5 is a drawing of a nozzle according to one embodiment of the present invention.

FIG. 6A is a photographic representation of one embodiment of the present invention attached to a Pratt & Whitney 4098 model engine.

FIG. 6B-Left is a photographic representation of the apparatus of FIG. 6A showing the spout assembly entering through the rear of the air bypass section to the left of the engine (as viewed from the front), and between the fan and compressor section of the engine.

FIG. 6B-Right is a photographic representation similar to FIG. 6B-Left, and showing the spout assembly placed through the fan exit vanes on the right side of the engine. The spout is coupled to the fan vanes to prevent movement.

FIG. 6C is a photographic representation showing placement of the apparatus of FIG. 6A as seen from the front of the engine, and above the centerline of the engine.

FIG. 6D is a close up photographic representation of the apparatus of FIG. 6A as seen from the front of the engine, and with the apparatus placed at about the same elevation as the centerline of the engine.

FIG. 6E is a close up photographic representation of the apparatus of FIG. 6C; the spout is placed to provide foam between compressor inlet guide vanes and to the compressor inlet.

FIG. 7 is a photographic representation, including a marked yardstick, and showing some relative dimensions of the apparatus of FIG. 6A.

FIG. 8A is a photographic representation of the apparatus of FIG. 6A placed into a General Electric CF34 engine installed on an aircraft.

FIG. 8B is a photographic representation similar to FIG. 8A from the rear of engine.

FIG. 8C is a close-up photographic representation of a portion of the apparatus of FIG. 8B.

FIG. 9 is a schematic representation of a system according to one embodiment of the present invention.

FIG. 10A is a graphical representation from an engine inlet looking aft, and showing the forward-facing surface of a spout assembly according to one embodiment of the present invention.

FIG. 10B is a graphical representation from an engine inlet looking aft, and showing the forward-facing surface of a spout assembly according to yet another embodiment of the present invention.

FIG. 11A is a top plan form view of an aircraft with buried engines, and showing a spout assembly according to one embodiment of the present invention.

FIG. 11B is a side view of the aircraft of FIG. 11A with a spout assembly according to a yet a different embodiment of the present invention.

FIG. 11C is a partial schematic representation of the inlet of an F135 engine and lift fan.

FIG. 11D is a partial schematic representation of the inlet of an F100 engine.

FIG. 11E is a photographic representation of the inlet of an RB199 engine.

FIG. 11F is a photographic representation of the inlet of an F135 engine.

FIG. 12A is a side elevational view of an aircraft having a turboprop engine.

FIG. 12B is a schematic representation of components including the engine, gear box, and propeller located within a nacelle, and representative of the engine mounting in FIG. 13A.

FIGS. 13A and 13B are drawings of multiple embodiments V.4 and V.5, respectively of spout assemblies according to various embodiments of the present invention.

### ELEMENT NUMBERING

The following is a list of element numbers and at least one noun used to describe that element. It is understood that none of the embodiments disclosed herein are limited to these nouns, and these element numbers can further include other words that would be understood by a person of ordinary skill reading and reviewing this disclosure in its entirety.

| | |
|---|---|
| 9 | Needle |
| 10 | engine |
| 10.2 | lift fan |
| 10.3 | gear box |
| 10.4 | propeller |
| 10.5 | direction of compressor rotation |
| 10.6 | bullet nose |
| 11 | inlet |
| 11.5 | front hub cover |
| 11.6 | shaft |
| 11.7 | strut |
| 11.8 | inner diametral surface of inlet |
| 12 | fan |
| 12.5 | splitter |
| 12.6 | compressor inlet quadrants |
| 13 | compressor |
| 14 | combustor |
| 15 | turbine |
| 16 | exhaust |
| 17 | fan bypass housing |
| 18 | bypass vanes |
| 19 | bypass structural strut |
| 20 | washing system |
| 21 | vehicle |
| 22 | source of chemicals |
| 23 | boom |
| 24 | source of water |
| 25 | source of electricity |
| 26 | source of gas |
| 27 | nucleation device |
| 28 | foam output |
| 29 | pump |
| 30 | nozzle |
| 32 | effluent collector |
| 33 | hose |
| 34 | support |
| 35 | reservoir |
| 37 | containment wall |
| 38 | heater |
| 40 | foaming system |
| 41 | foam connection |
| 42 | tubing |
| 50 | spout assembly |
| 51 | spout nozzle |
| 52 | spout quick connection |
| 53 | spout member, rigid; segment |
| 54 | spout attaching mechanism |
| 55 | spout extension |
| 56 | spout nozzle actuator/servo |
| 57 | spout ball joint |
| 58 | spout socket joint |
| 59 | pivotal coupling |
| 60 | receptacle |
| 62 | sensor |
| 64 | bracket |
| 70 | yardstick |
| 80 | processing unit (recycle, purify) |
| 90 | aircraft |

### DESCRIPTION OF THE PREFERRED EMBODIMENT

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates. At least one embodiment of the present invention will be described and shown, and this application may show and/or describe other embodiments of the present invention, and further permits the reasonable and logical inference of still other embodiments as would be understood by persons of ordinary skill in the art.

It is understood that any reference to “the invention” is a reference to an embodiment of a family of inventions, with no single embodiment including an apparatus, process, or composition that should be included in all embodiments, unless otherwise stated. Further, although there may be discussion with regards to “advantages” provided by some embodiments of the present invention, it is understood that yet other embodiments may not include those same advantages, or may include yet different advantages. Any advantages described herein are not to be construed as limiting to any of the claims. The usage of words indicating preference, such as “preferably,” refers to features and aspects that are present in at least one embodiment, but which are optional for some embodiments, it therefore being understood that use of the word “preferably” implies the term “optional.”

Although various specific quantities (spatial dimensions, temperatures, pressures, times, force, resistance, current, voltage, concentrations, wavelengths, frequencies, heat transfer coefficients, dimensionless parameters, etc.) may be stated herein, such specific quantities are presented as examples only, and further, unless otherwise explicitly noted, are approximate values, and should be considered as if the word “about” prefaced each quantity. Further, with discussion pertaining to a specific composition of matter, that description is by example only, and does not limit the applicability of other species of that composition, nor does it limit the applicability of other compositions unrelated to the cited composition.

Various references may be made to one or more methods of manufacturing. It is understood that these are by way of example only, and various embodiments of the invention can be fabricated in a wide variety of ways, such as by casting, sintering, welding, electrodischarge machining, milling, as examples. Further, various other embodiment may be fabricated by any of the various additive manufacturing methods, some of which are referred to 3-D printing.

This document may use different words to describe the same element number, or to refer to an element number in a specific family of features. It is understood that such multiple usage is not intended to provide a redefinition of any language herein. It is understood that such words demonstrate that the particular feature can be considered in various linguistical ways, such ways not necessarily being additive or exclusive.

Incorporated herein by reference in its entirety is PCT application US2014/058865, filed Oct. 2, 2014, and titled CLEANING METHOD FOR JET ENGINE.

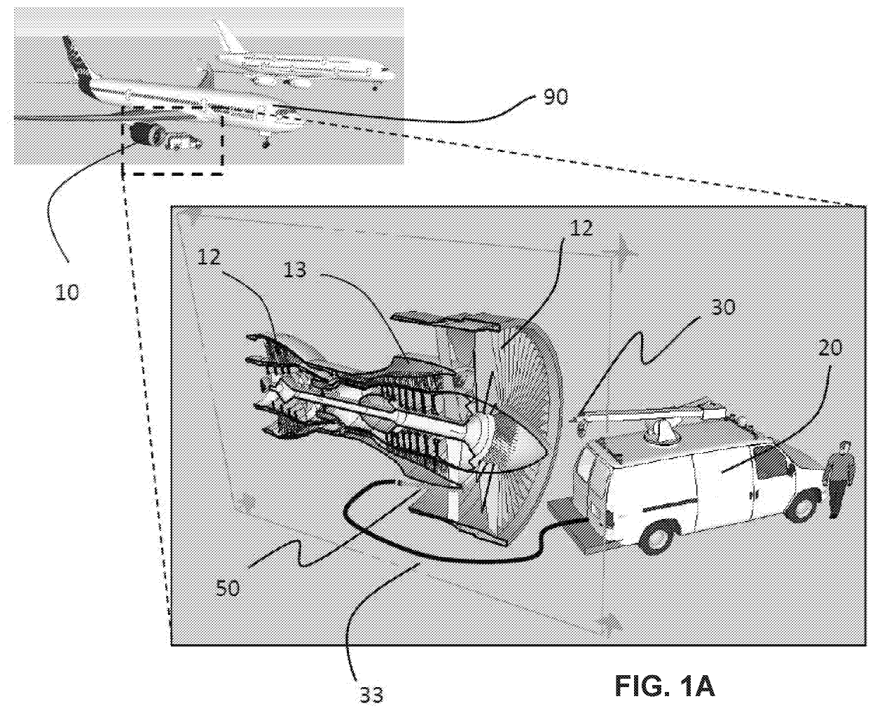

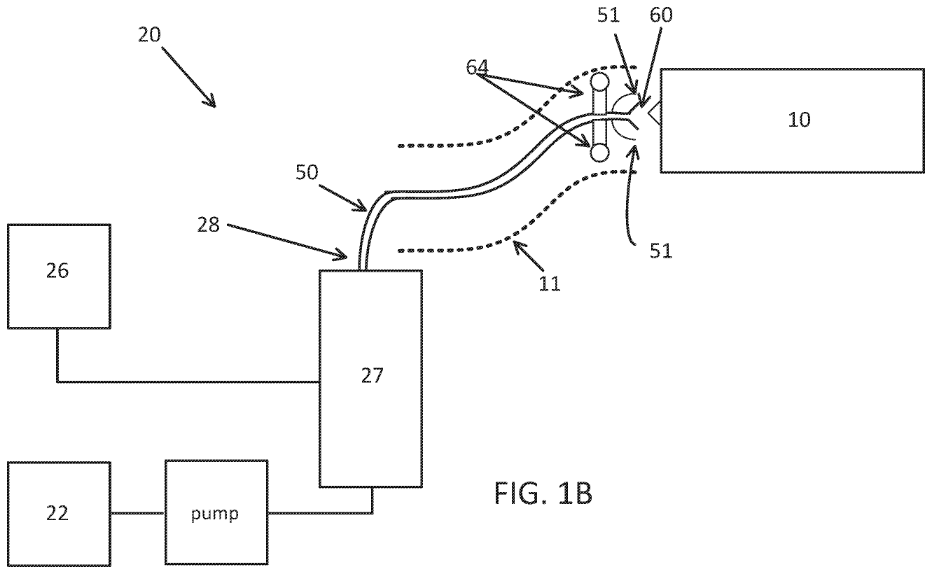

FIG. 1A is a graphical representation of a washing cleaning system 20 with spout 50 according to one embodiment of the present invention. Illustrated is a washing system 20 applied to the cleaning of a gas turbine engine 10 mounted on aircraft 90, while it is understood that various embodiments of the present invention contemplate the cleaning of any object. Washing system 20′ provides foamed cleaning product via nozzle 30, into the inlet 11 of engine 10, and/or it can at the same time or in combination with, provide cleaning product (foam) via hose 33 and through spout 50. In still further embodiments of the present invention, a foamed cleaning product is provided through spout 50 into the engine core, and an atomized liquid cleaning product (the same or different cleaning product as the foamed product) is provided into the engine inlet via an atomizing nozzle 30′ (not shown).

Spout 50 is placed and attached to engine 10 between the fan 12 section and compressor 13 section. Spout 50 is adapted and configured for delivery of a foamed cleaning product into the object to be cleaned. Therefore, the form and dimensions of spout 50 are selected to provide the foamed product with minimal changes to the structure and energy state of the foam. In some embodiments, the various flow features of spout assembly 50 are selected so as to not atomize the foam, and instill other embodiments to have minimal pressure drop, so as to not substantially compress the foam structure. In some embodiments, the nozzle assembly has a pressure drop under 50 psi (the pressure drop from foam flowpath to ambient pressure). However, the present invention contemplates yet other embodiments in which the pressure drop is less than about 100 psi.

FIG. 1B is a block diagram representation of a system according to one embodiment of the present invention for a liquid pump 29 receives a supply of liquid cleaner from a source 22. The pressurized cleaning liquid is provided to a nucleation device 27. Also provided to the nucleation device 27 is pressurized gas from a source 26. Source 26 can be from a nearby building, a cylinder of pressurized gas, or from a pump. Nucleation device 27 mixes the cleaning liquid and the gas to a higher energy, foamed state. The foam output from device 27 is provided to the inlet of spout assembly 50, and from nozzle 51 into the inlet of the engine.

Although what is shown and described is the application of a cleaning system 20 to a conventional high bypass fan engine, it is further understood that yet other embodiments are applicable to any type of gas, steam, or water turbine, including as examples pure turbo jets, leaky (low bypass) turbo jets, turbo props, unducted fan engines, and engines in which the fan is driven via gearing.

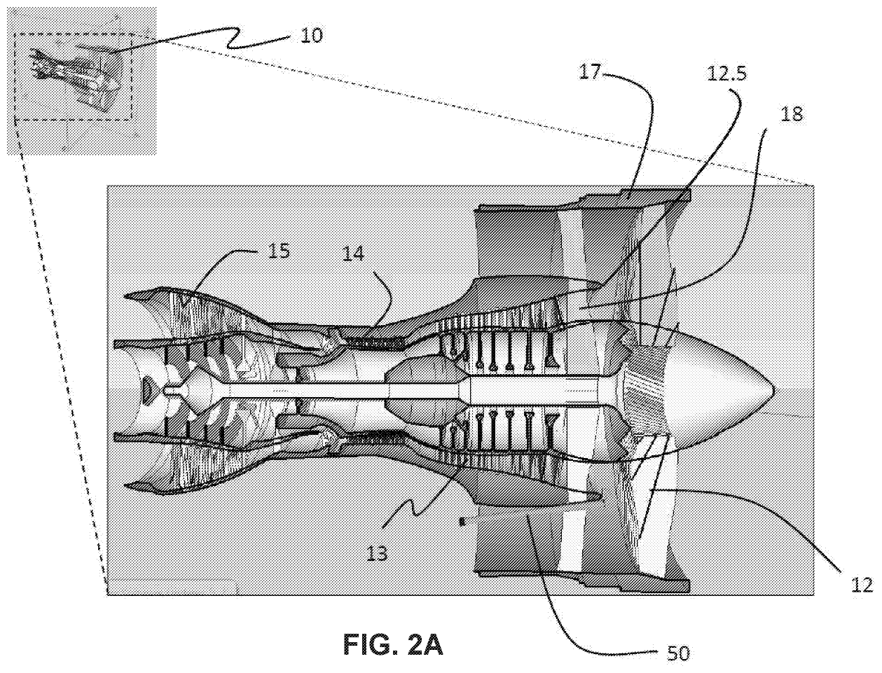

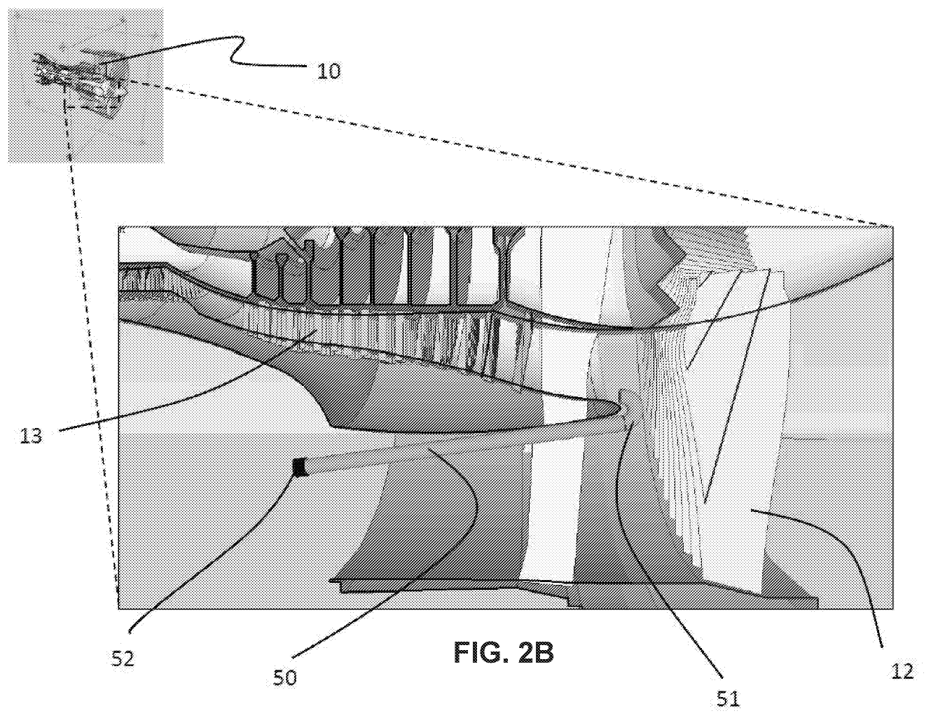

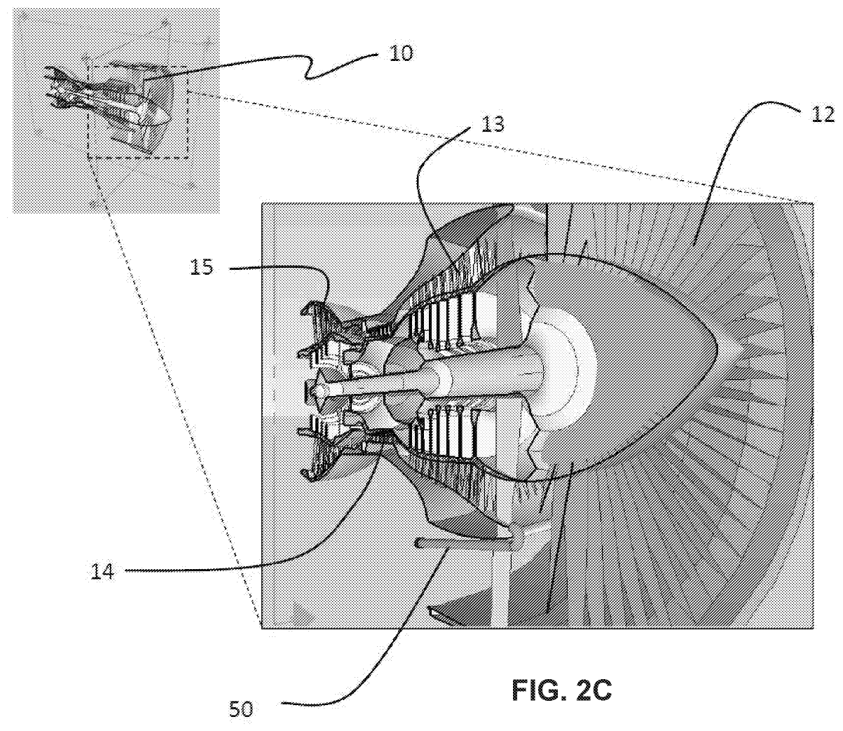

FIG. 2A graphical represents the cross-section view of engine 10 with spout assembly 50 in place and attached to fan bypass vanes 18. The distal end of spout assembly 50 preferably curves around the nose of a splitter 12.5 that separates the air propelled by the fan into either the bypass duct or the engine core. FIG. 2B graphically represents a close up view of the spout 50 placed such that the spout nozzle 51 allows for cleaning of product (foam) to enter the compressor 13 section effectively.

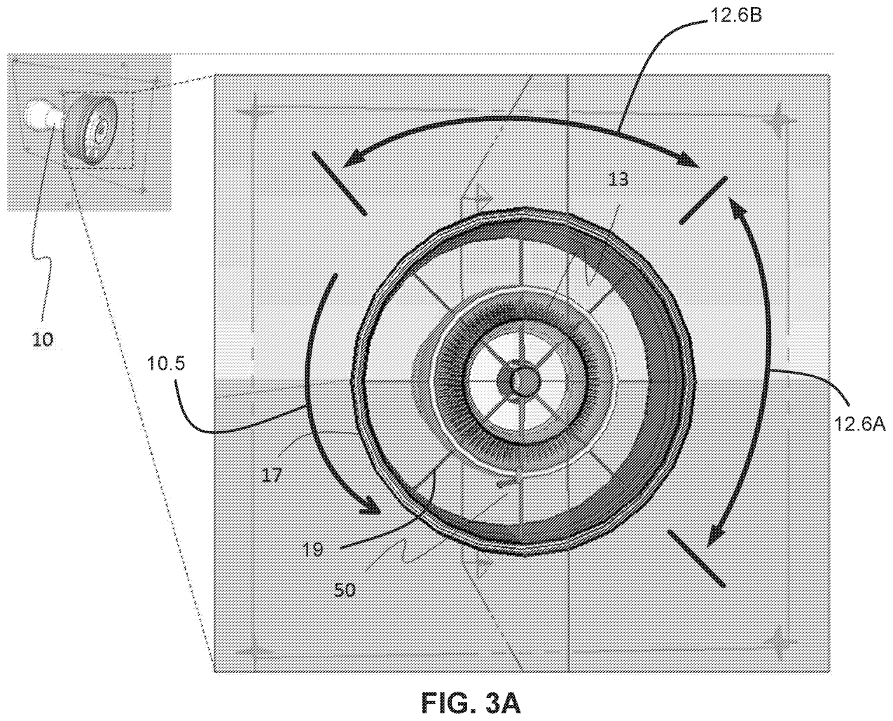

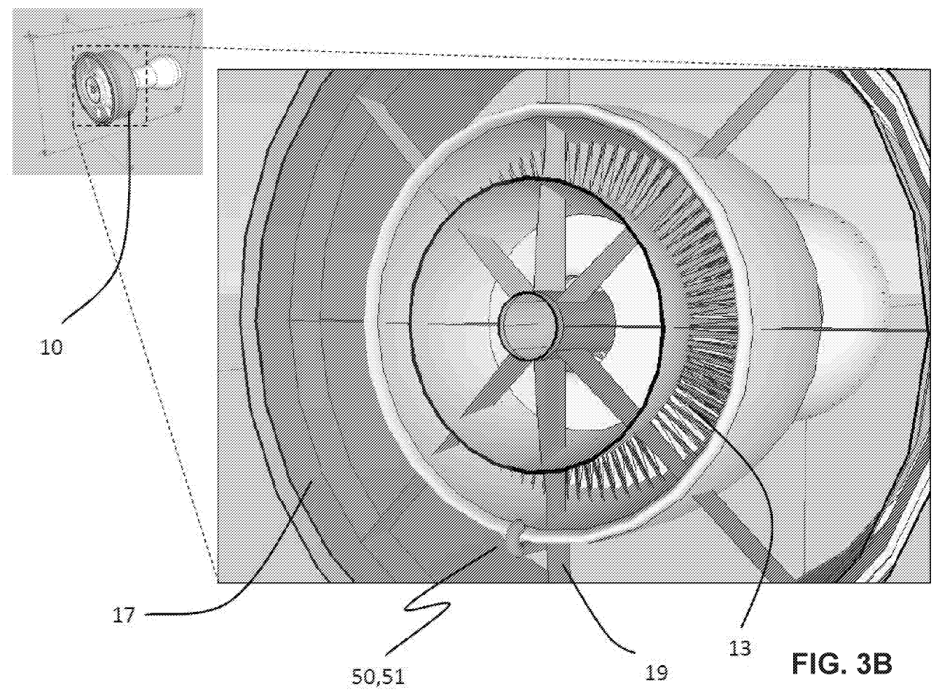

FIG. 2C demonstrates placement of spout 50, such that the directed injected chemical products (such as cleaning foam and water) enter the compressor 13 section; while it is understood that the presented invention spout 50 contemplates placement to be anywhere along the intake annulus of compressor 13. FIG. 3A permits persons of ordinary skill in the art to visualize that multiple spout assemblies 50 can be placed at any circumferential location along the annulus of compressor inlet.

FIG. 3B further represents a close up view of the spout nozzle 51 and spout 50 attached to bypass fan structure 19 and placed generally below the centerline of the engine. Nozzle 51 hooks around the annulus ring edge 12.5 (splitter) of compressor 13 of engine 10. FIG. 3B shows that the distal most nozzle 51 of spout assembly 50 is located proximate to the outer flow diameter of the splitter nozzle of the engine on the core flow side. However, those of ordinary skill in the art will recognize that the length of the 180 degree bend can be extended so as to place spout nozzle 51 at different radial locations, including locations closer to the inner diameter of the core flowpath, as well as locations generally above the centerline, which may assist in providing an even distribution of flow within the engine.

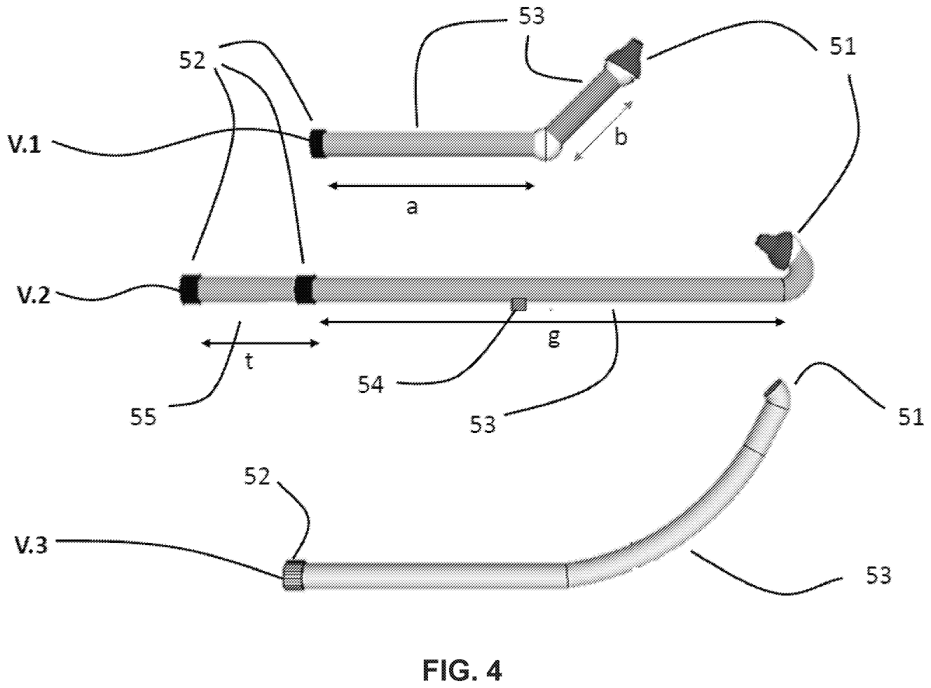

FIG. 4 are drawings of various spout assembly 50 embodiments. In one embodiment, the spout assembly 50 includes a quick connect fluid connection 52 followed by one or more pipe members 53 and a nozzle 51. Spout 50 can also be one rigid pipe member 53 pre-shaped to a specific engine model as shown in version V.3. In some embodiments, it is preferably to have at least one pipe member 53 that provides a substantially open flowpath with rigid walls. It is anticipated that the use of some embodiments will be facilitated by having a rigid section for improved handling so as to better place the J nozzle from a distance (i.e., such as the length of the nacelle fan duct or any internal fan duct). Spout 50 in some embodiments is contemplated to also allow for flexibility and maneuverability, as in versions V.1 and V.2. V.1 is shown in the form of a ball and socket (similar to an aquarium ball and socket pipe, by Lifeguard Aquatics model ARP270850), where it can have multiple segments, and end with nozzle 51. V.2 is shown with an extension 55 of dimension t, which can be useful in those spout assembly embodiments being adapted to engines of different sizes and configurations. All versions may or may not have an attachment mechanism 54 that couples assembly 50 to one of the radial struts 19 in the bypass duct. Yet mechanism 54 may alternatively also couple to the bypass housing 17 (not shown).

It can be seen that V.2 is similar to the assembly 50 shown in FIG. 3A. In contrast, V.3 shows a member 53 that extends distal nozzle 51 to a location that is radially more inward than the location of the nozzle 51 of V.2. The assembly shown as V.1 further illustrates that the flow out of the distal nozzle 51 can be oriented to spray radially inward, or even partially forward, such that the foam is directed aft by the air exiting the rotating fan. Still further, V.1 and V.2 show that it is possible to have converging nozzles 51 in some embodiments of the present invention, wherein the convergence geometry is adapted and configured to provide slightly higher velocity to the foam, but to still not atomize the foamed fluid, or substantially change the characteristics of the foam cells. In a preferred embodiment, the inner flow path of the spout assembly is adapted and configured to provide no more than a minimal decrease in the energy state of the foamed product.

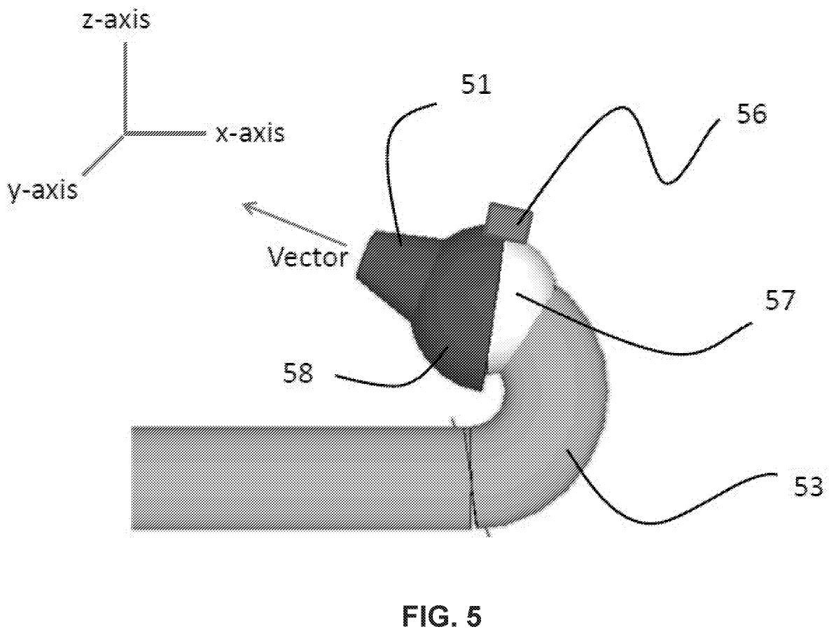

FIG. 5 is a close up view of one embodiment of spout nozzle 51. In this embodiment, the nozzle 51 is controlled with a motor/actuator 56 to rotate nozzle 51 and move the pointing vector (exit of product) in three-dimensional space. Motor/actuator 56 is shown schematically. It is understood that ball 57 and socket 58 can be adapted and configured to provide a static surface (on ball 57) coupled to one end of the actuator, and a movable surface (on socket 58) attached to the other end of the actuator. In yet another embodiment, nozzle 58 can be spring loaded to an angular position, such as directly aft (or parallel to the X-axis shown on FIG. 5). On the opposite end of the actuator is a wire that, in one embodiment, attaches near the top of socket 58 (i.e., the same location as actuator 56 is attached to), the wire running along a guided path such as around the forwardmost curved end of member 53, and then extending aft. The aft end of the wire (not shown) is attached to a device such as a linear actuator. The actuator can pull on the wire, and thus cause socket 58 (which is coupled to ball 57 so as to move and be guided along a particular path by a track between the socket and ball). Pulling on the wire causes the output vector of nozzle 51 to have increasingly more of a component along the Z-axis. Releasing the tension on the wire permits the spring to pull the socket 58 back toward its initial position. In yet another embodiment, nozzle 58 may have two or more motor/actuators 56 on a track and pinion system 90-degrees to each other around the socket 58 (coupled to ball 57), such that the actuation of each independent actuator 56 results in a range of nozzle 51 movement to point at a particular direction in 3-dimensional space.

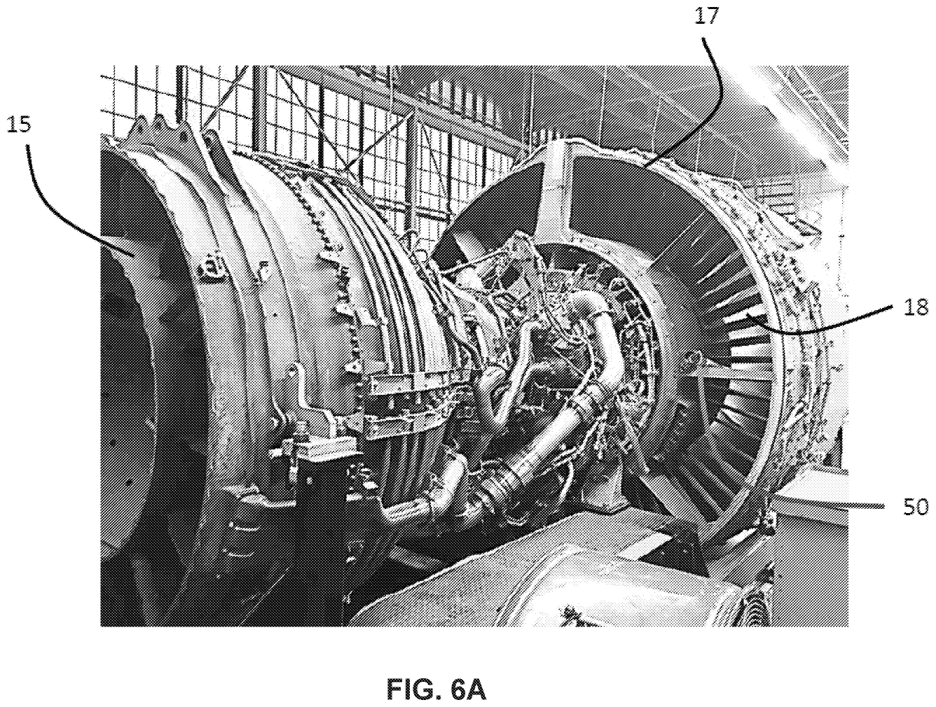

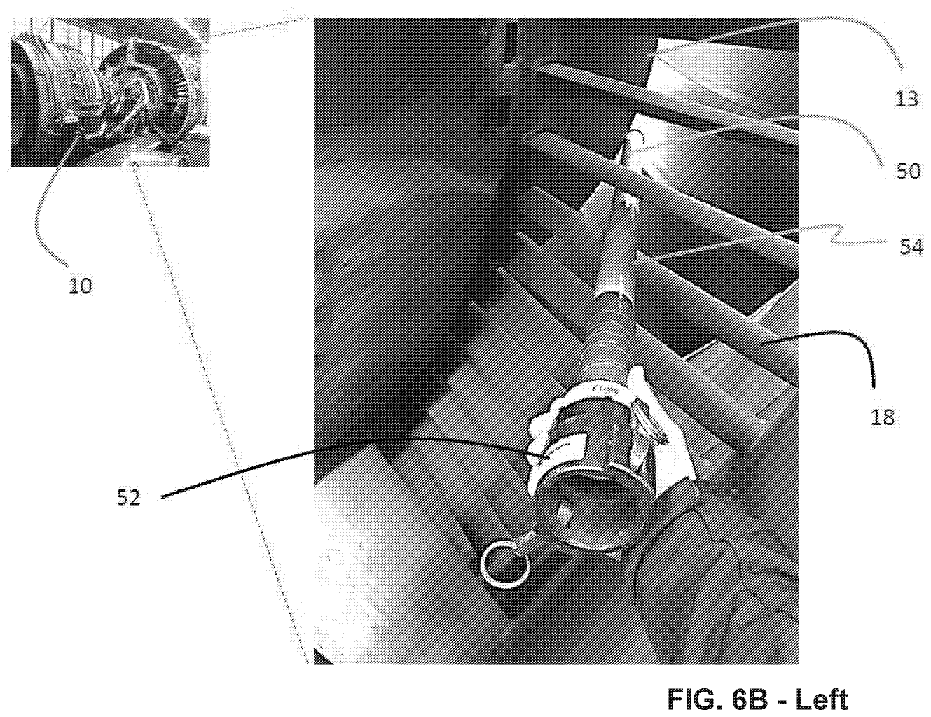

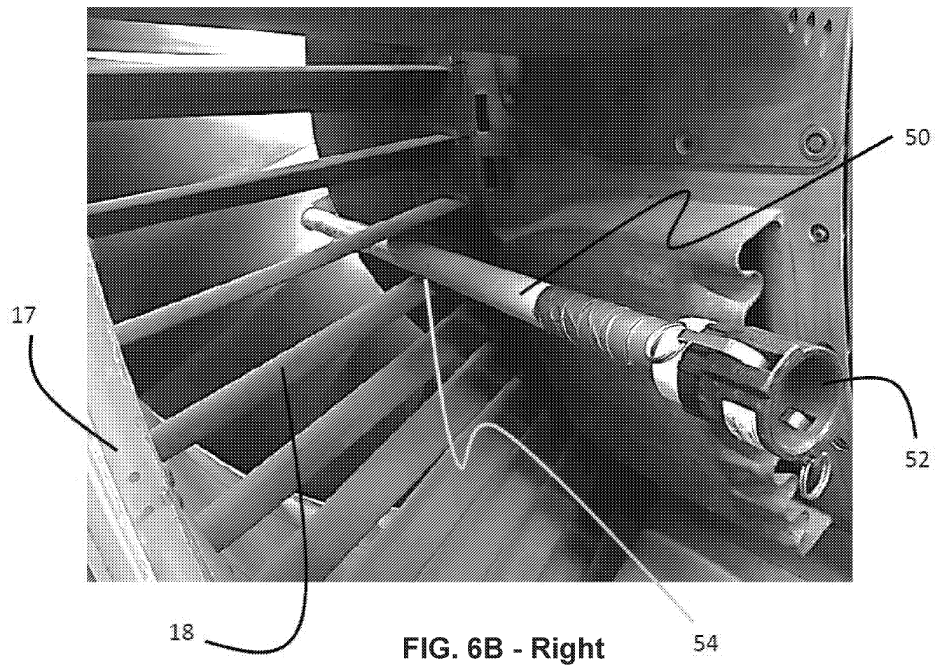

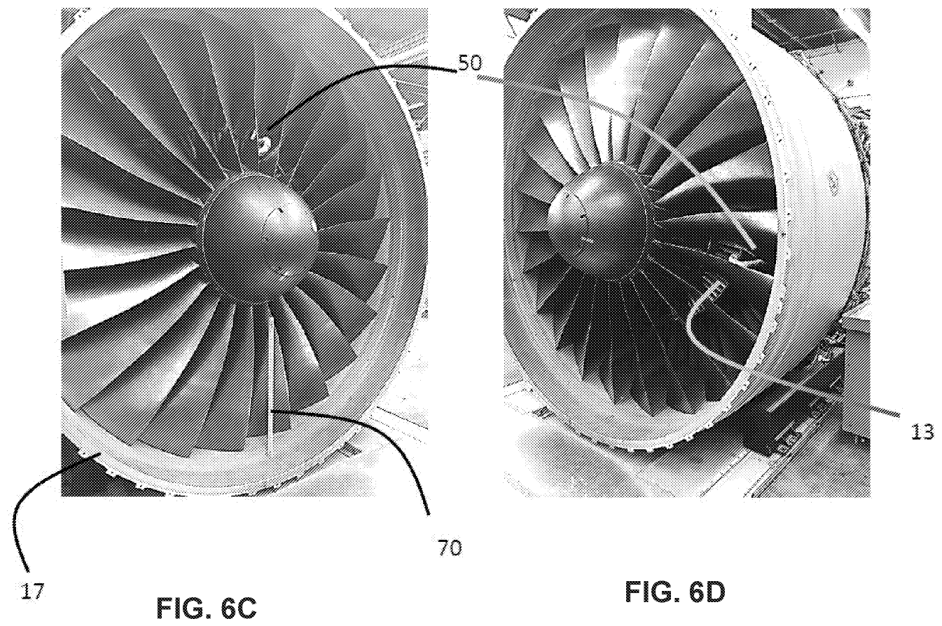

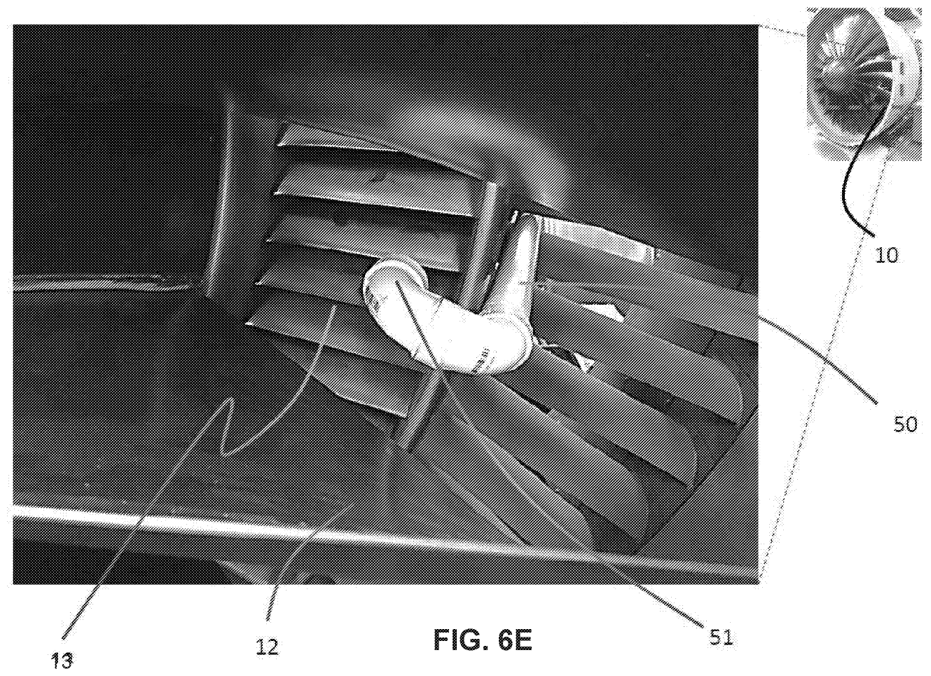

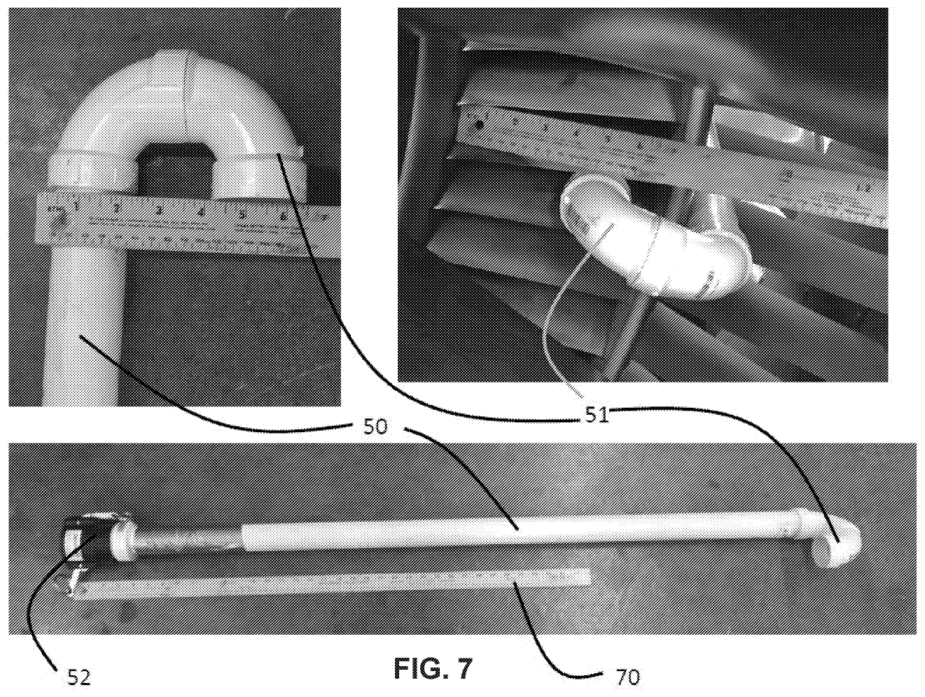

FIG. 6A is a picture of spout 50 mounted inside a PW 4098 engine. FIG. 7B-Left is a picture from the rear of bypass fan section Left side of engine 10, and illustrates how spout 50 can go through fan vanes 18 and reach to hook around the inlet annulus of compressor 13 section. Illustrated is a contemplated quick connect 52 (Banjo 2″ cam lock) for connection to other components of the foam washing system 20.

FIG. 6B-Right is a picture from the rear of bypass fan section Right side of the engine. This embodiment is similar to that in FIG. 7B-Left, and demonstrates that the spout assembly 50 can be placed at any (or multiple) locations inside the fan housing 17. Attachment 54 location affixes safely spout 50 to fan vane 18 so that it does not shake or move off during operation.

FIGS. 6C and 6D are photographs that demonstrate placement and relative size of spout 50, including above the centerline and lateral to the centerline, respectively. Some embodiments contemplate entry of the foamed product into the compressor at a vertically high location (such as FIG. 6C). The dispersion of foam is aided by the influence of gravity to provide even distribution within a compressor. In still further embodiments (such as FIG. 6D), a lateral location is preferred. It is expected that in some engines it is preferable to introduce the foamed product at a position generally lateral to the engine centerline, and with the rotation of the engine being generally upward at that point such that the rotating compressor blades immediately aft of the spout nozzle tend to lift the foamed product up and around the compressor flowpath. However, yet other embodiments of the present invention include spout nozzles located laterally to an engine centerline such that the rotation of the blades immediately aft of the nozzle move the foam initially downward toward the bottom of the flowpath. In still further embodiments, the annular compressor inlet includes a plurality of nozzles delivering foamed product in a quadrant of the annulus, aft of which the compressor blades initially move the foamed product with some upward vector. FIG. 3A identifies two such quadrants 12.6A and 12.6B. For foam that is provided in either of these quadrants, at least a portion of the foamed product is lifted toward the top of the engine. Spout 50 is placed at one or many locations at the same time during operation as shown by Position A and/or B.

FIG. 6E is a picture close-up of spout 50 from the front of engine 10 and just behind fan 12 blades. This contemplated simplified spout 50 invention has a hook that allows it to come from the rear of the bypass section and curve around the nose of the splitter to provide product (such as foam and water) via nozzle 51 into the compressor section 13.

FIG. 7 is a picture showing spout 50 with relative dimensions. Spout 50 in one embodiment is made of 2 inch PVC pipe with a curved hook nozzle 51 and quick-connect fitting 52. The inner diameter of the delivery pipe of spout 50 is preferably greater than ¼ inch in order to not reduce the foam quality and cell size. More preferably, the inner diameter of the piping providing the foam is greater than about one inch. For those embodiments with smaller pipe diameters, it is preferable to have multiple points for foam entry into the engine flowpath. By having multiple nozzles for delivery of foam, the total flow area of the nozzles if roughly the same as the cross sectional flow area of the delivery pipe. In some embodiments, the foam is initially generated in a nucleation chamber having an outlet with a cross sectional flow area (as described in the referenced PCT application). Preferably, the flow area of the flowpath between the outlet of that nucleation chamber to the aperture of nozzle 51 is substantially constant. In those applications having smaller diameter pipes for nozzle assembly 50, it is preferred that there be a sufficient number of nozzles used to provide the same total flow area as the cross sectional flow area of the outlet of the nucleation chamber. However, the present invention does contemplation reductions in this flow area from creation in the nucleation chamber to injection into the engine of up to about twenty percent, and further other embodiments provide for increases in that flow area.

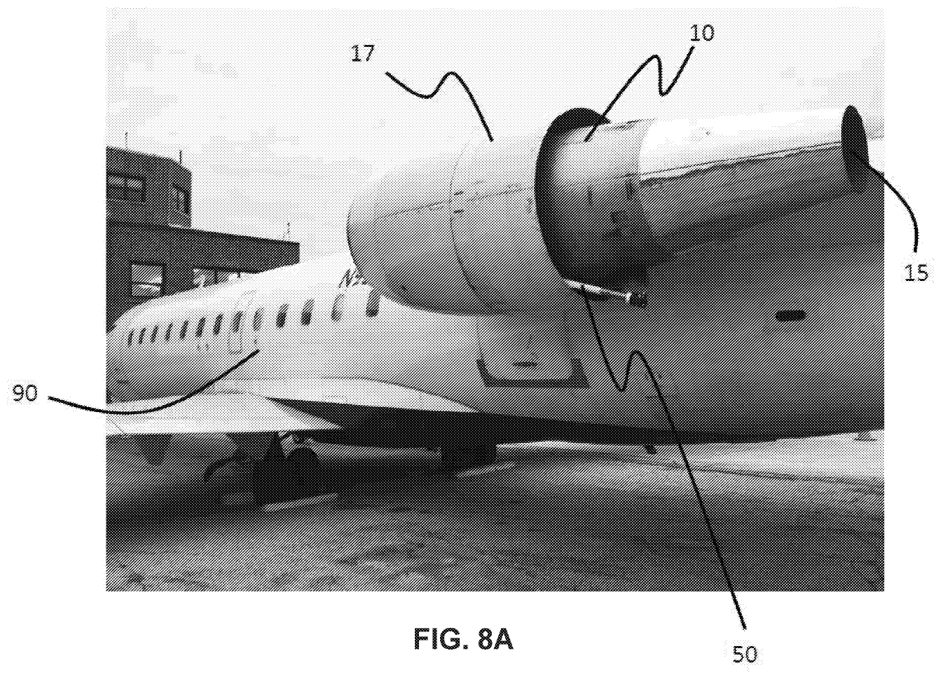

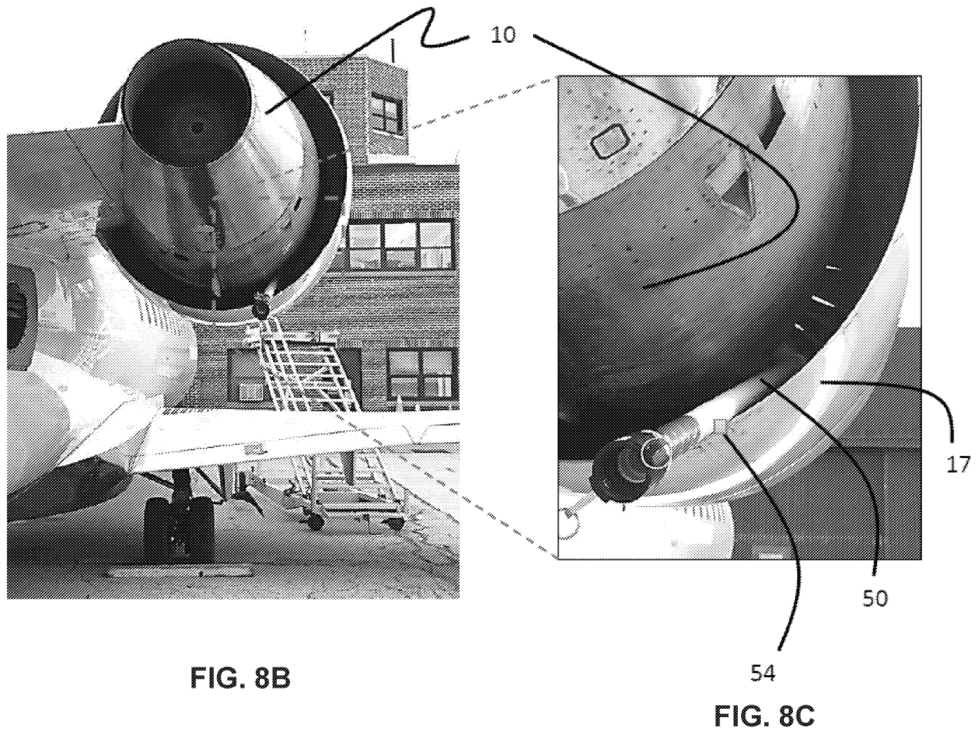

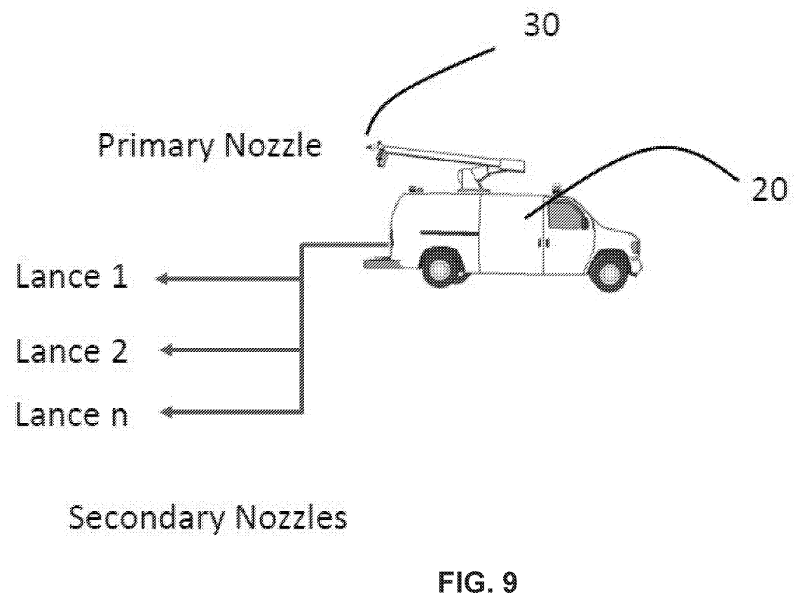

FIG. 8A is a picture of spout 50 placed on an aircraft with small to medium sized engines (General Electric CF34) by way of example. Spout 50 is placed between fan bypass housing 17 and engine 10 core. FIG. 8B is another view to depict placement of spout 50 and affixed to the nacelle fan housing 17 via adjustable attachment mechanism 54. FIG. 9 is a schematic that demonstrates the use in systems having multiple spout assemblies 50 (i.e. Lance 1, Lance 2, etc.), each provided with foam from one or more nucleation chambers in system 20 in conjunction of foam wash system 20.

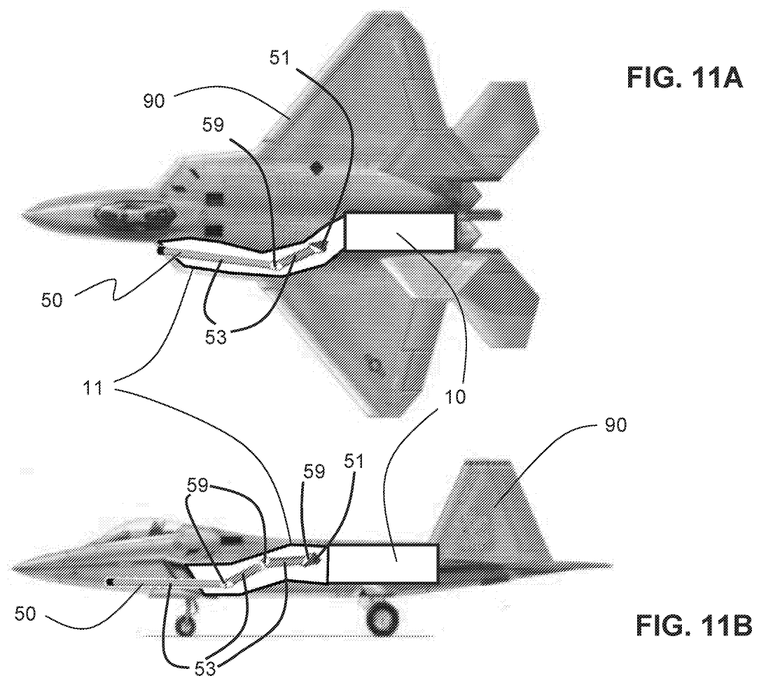

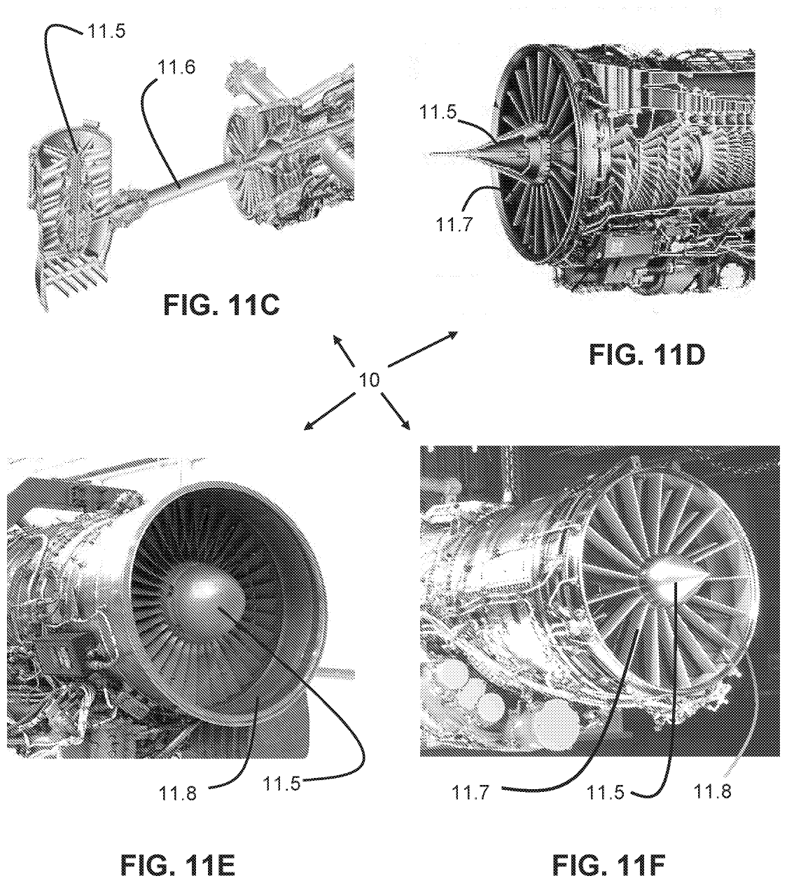

Referring again to FIG. 7, it can be seen that in one embodiment the spout assembly 50 maintains a generally circular cross sectional shape along the foam flowpath from quick connect 52 to nozzle 51. As best perceived from the upper right photographic representation of FIG. 7, the spout assembly 50 has a forward-projecting frontal area that can be considered as a rectangle with opposing rounded ends separated by flat, linear sides. Further, it can be seen that the aerodynamic shape of spout assembly 50 as shown in FIG. 7 has a larger diameter directly in front of the engine flow splitter where two pieces of tubing come together, and then blending aft along the curved 90 degree sections of tubing (see FIG. 11A).

However, yet further embodiments of the present invention contemplate “J” sections (i.e., the J section seen in the upper left corner of FIG. 7) that are adapted and configured for reduced aerodynamic disturbance into the fan and compressor flowpaths, but still maintaining sufficiently large cross sectional flow area so as to not reduce the quality of the foam. As one example, the forward-facing, rounded blunt nose of the J section (seen in the upper left corner of FIG. 7) can be replaced with a more tapered and pointed shape so as to create less aerodynamic disturbance when air exiting from the fan impinges on the stagnation point of the J section.

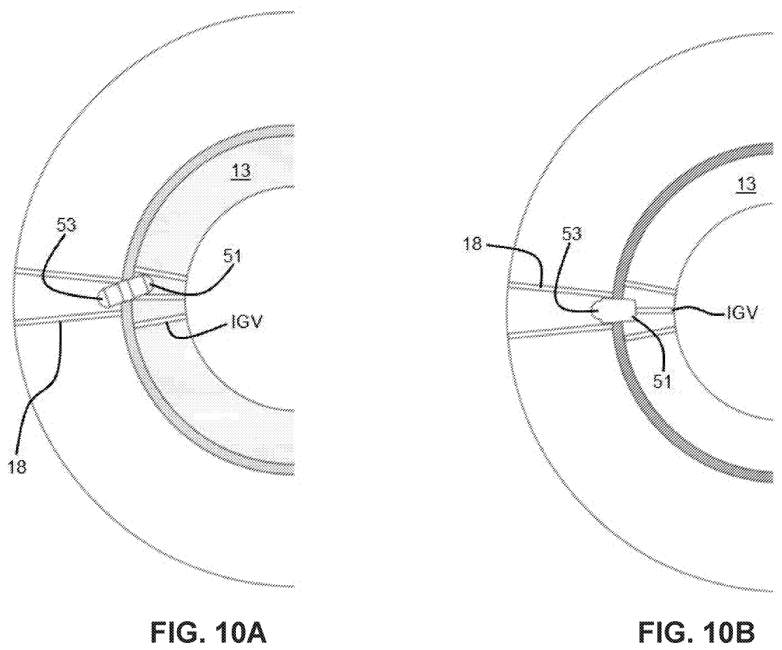

Still further, and referring to the upper right corner of FIG. 7, it can be seen that the circular exit area of the J-section is spaced apart from the outer diameter of the core flowpath. In yet other embodiments, the exit of the J section is a flatter and more squared annular sector that is located more closely to the outer diameter of the core flowpath (i.e., the outwardmost inner surface of the splitter). A version of such a foam exit is shown in FIG. 10B. The nozzle shown in FIG. 10B further includes a central locating feature that is adapted and configured to fit over the front of a compressor inlet guide vane. By achieving a coupling between the J section and the leading edge of the inlet guide vanes it is possible to enhance the circumferential (lateral) stability of the spout assembly relative to the compressor inlet and fan bypass struts 19, and still further to minimize the possibility of the forwardmost end of the spout assembly 50 coming loose and entering the compressor as a foreign object.

Still further embodiments of the present invention pertain to the cleaning of engines with relatively long aircraft inlet structures, and further including those engines receiving air through a “serpentine” or S-shaped inlet duct. Such inlets are typically found on various military aircraft. The additional length and/or S-shape to the duct presents additional problems to the maintenance crew. In some cases, the length and/or shape of the duct prevents the use of a straight, unsupported spout assembly. In some cases the length is great enough that an unsupported spout assembly could pose a risk to damaging the interior surface of the inlet, especially if the inlet has applied onto it coatings that should not be touched or scratched. In yet other embodiments, the serpentine shape of the duct may prevent the maintenance personnel from having a clear line of sight of the engine inlet, thus making it difficult to know if the spout assembly has been correctly located.

Various embodiments of the present invention include spout assemblies that comprise rigid tubing in a piecewise segmented shape, or alternatively in a curved shape. In still further embodiments, the segments may be attached by means of pivoting joints so as to permit maintenance personnel to change the orientation of one segment relative to another segment. These pivoting joints may be pivotal about a single axis, whereas in other embodiments the joints permit swiveling about two axes. However, yet other embodiments recognize that some maintenance operations may prefer spout assemblies that have a shape adapted and configured for a single family of inlets (such as the inlets of a single family of aircraft, such as for the F-35). In such cases, the spout assemblies may be pre-formed from preferably rigid tubing to the specific shape, with (optionally) no pivoting joints.

In still further embodiments, the spout assemblies include means for positively locating the spout assembly relative to the face of the engine. Such locating means can include one or more features on the end of the spout that at adapted and configured to have shapes that are complementary to the shape of an engine inlet feature. As one example, some engines include relatively pointed, conical engine covers 11.5, and seen in FIG. 11F. With some engines, these hub covers (sometimes referred to as a “bullet” nose) are stationary, having a fixed location relative to inlet struts 11.7. In yet other embodiments, the hub cover 11.5 may be a rotating piece.

In some embodiments, the spout assembly would include a complementary-shaped feature (such as a “funnel”) on the end of the spout assembly. The maintenance personnel can guide the complex-shaped spout assembly through a serpentine inlet and place the funnel-shaped receptacle onto the conically-shaped front cover 11.5. Preferably, the foam nozzles are located circumferentially around the end receptacle of the spout assembly, although the present invention also contemplates those embodiments in which the foam exit nozzles are one or more annular, sector-portions located within the interior of the conical and receptacle.

In still further embodiments, the distalmost end of the spout assembly can include one or more receptacles that have a shape that is complementary to a portion of one or more struts 11.7. Still further, yet other embodiments can include locating features that come into contact with the inner diametral surface 11.8 of the engine inlet. In this latter case, these locating features can include semi-rigid struts attached at one end to the spout assembly, and having at the other end a rotatable wheel, as one example. The semi-rigid nature of such a locating feature lessens the chance of damage to the inlet, since this locating bracket simply bends out of the way if brought into contact with the inner surface of the inlet duct. Still further, having a rotating wheel (or ball) on the end of the locating strut further limits any scratching of the inlet interior surface

FIGS. 11D and 11E show examples of other front hub covers 11.5 on yet other engines. A corresponding receptacle on the distalmost end of the spout assembly would be adapted and configured to provide positive location on these surfaces. It is understood that the receptacle need not have a continuous, three dimensional contact surface. Optionally, the means for locating can include, as one example, one or more rings that touch the corresponding hub cover 11.5 and limit the aftward axial movement of the spout assembly when the spout assembly is fully inserted into the inlet.

FIG. 11C shows another type of propulsion package that includes a lift fan powered by a shaft 11.6 coupled to the front face of the engine. In such embodiments, one spout assembly can include a locating receptacle that provides positive location on the hub assembly 11.5 of the lift fan (if stationary), or alternatively on the struts, the inner surfaces of the flow surface, or on adjacent aircraft or lift fan static features. Still further, a spout assembly for providing foam to the engine would include a receptacle that is placed in contact with the cylindrical cover of the shaft 11.6. As one example, such a receptacle could be a complementary-shaped cylindrical cover that has an angular extent of less than about one hundred eighty degrees. A plurality of foam exits (such as in a partially toroidal shape) can be placed around the receptacle of the shaft cover to provide foam to the engine inlet.

Various embodiments of the present invention include the following apparatus and methods A, B, and C for generating foam from a liquid cleaning agent and pressurized gas:
A. One embodiment of the present invention pertains to an apparatus for foaming a water soluble liquid cleaning agent. Some embodiments include a housing defining an internal flowpath, the flowpath having first, second, and third flow portions arranged sequentially, said housing having a gas inlet, a liquid inlet for the water soluble cleaning agent, and a foam outlet, the first flow portion including a gas plenum that is adapted and configured for receiving gas under pressure from the gas inlet and including a plurality of apertures, the plenum and the interior of the housing cooperating to form a mixing region receiving liquid from the liquid inlet and receiving gas expelled from the apertures, the first portion providing a first foam of the liquid and the gas into the internal flowpath, the second flow portion receiving the first foam and flowing the first foam past a foam growth member adapted and configured to provide surface area for attachment and merging of cells of the first foam to create a second foam; and the third flow portion receiving the second foam and flowing the second foam through a foam structuring member adapted and configured to reduce the size of at least some of the cells of the second foam to create a third foam provided to the foam outlet.
B. Another embodiment of the present invention pertains to a method for foaming a water soluble liquid cleaning agent. Some embodiments include mixing the water soluble liquid cleaning agent and a pressurized gas to form a first foam, flowing the first foam over a member and increasing the size of the cells of the first foam to form a second foam, and flowing the second foam through a structure and decreasing the size of the cells of the second foam to form a third foam.
C. Yet other embodiments pertain to an apparatus for foaming a water soluble liquid cleaning agent. Some embodiments include means for mixing a pressurized gas with a flowing water soluble liquid to create a foam, means for growing the size of the cells of the foam, and means for reducing the size of the grown cells.

Although various embodiments of the present invention have been shown and described in conjunction with various means for creating a foamed cleaning agent, it is understood that in yet other embodiments, the foamed cleaning agent can be created in any manner. Various embodiments of the present invention pertain simply to any of the various spout assemblies, and their alternatives, shown and described herein, without any means for creating foam of any type.

Still further embodiments of the present invention contemplate engine washing of buried engines in which the front bullet nose of the engine is a rotating component. In such applications the receptacle at the end of the spout assembly can be located on any static structure on the front of the engine, or in the aircraft inlet proximate to the engine front face. In yet other embodiments, the receptacle on the spout assembly is supported by a bearing and is able to spin with the bullet nose. It is understood that the engine foam washing procedure preferably uses the engine starter to rotate the engine. Therefore, the engine and the spout receptacle would be rotating at relatively low rpm.

FIG. 11A shows the view from the top of the planform of an aircraft 90 with a pair of buried engines 10, such as an F-22. FIG. 11B shows an orthogonally arranged side view of the aircraft 90 and inlet 11. It can be seen in FIG. 11A that the inlet varies in position laterally, and in FIG. 11B it can be seen that the inlet 11 flowpath varies in position vertically. As a result, some embodiments employ a spout assembly 50 that includes multiple segments 53 separated and held in relative orientation by one or more pivotal couplings 59.

FIG. 11A shows a first spout assembly 50 having two preferably rigid piping segments 53 connected together by a single pivoting coupling 59. It can be seen that the foam exit nozzle 51 is located a first, longer distance from the front face of engine 10. In contrast, the spout assembly 50 shown in FIG. 11B includes multiple rigid segments 53, interconnected and oriented relative to one another by a pair of pivotal joints 59. The spout assembly 50 of FIG. 11B has more degrees of freedom for placement of foam nozzle 51, as compared to the spout assembly 50 of FIG. 11A. Because the spout assembly of FIG. 11B has more degrees of freedom than the spout of FIG. 11A, the spout of FIG. 11B can be oriented to more closely follow the centerline of the S-shaped inlet duct 11, and because of these additional degrees of freedom the nozzle 51 can also be located in a more desirable location. In addition, the increased number of degrees of freedom permits additional total length and reach of the spout assembly into the inlet, with less likelihood of rubbing the inner surface of the inlet duct 11.

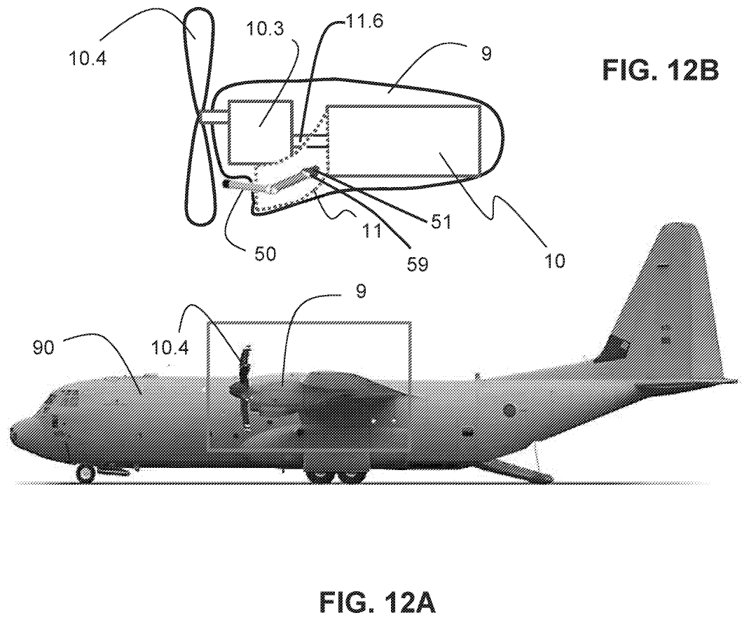

FIGS. 12A and 12B depict yet another embodiment of the present invention directed toward turboprop applications. FIG. 12A shows a C-130J aircraft 90, with a nacelle 9 and propeller 10.4. FIG. 12B shows schematically that nacelle 9 includes in it an engine 10 driving a gearbox 10.3 by way of a shaft 11.6. The inlet 11 is located underneath gearbox 10.3, although other embodiments of the present invention pertain to inlets located to either side of the gearbox, above the gearbox, or other locations. A multiple segment spout assembly 50 is shown entering inlet 11 just aft of propeller 10.4, and being adapted and configured to point the nozzle 51 (supported by a pivotal coupling 59) toward the inlet face of engine 10.

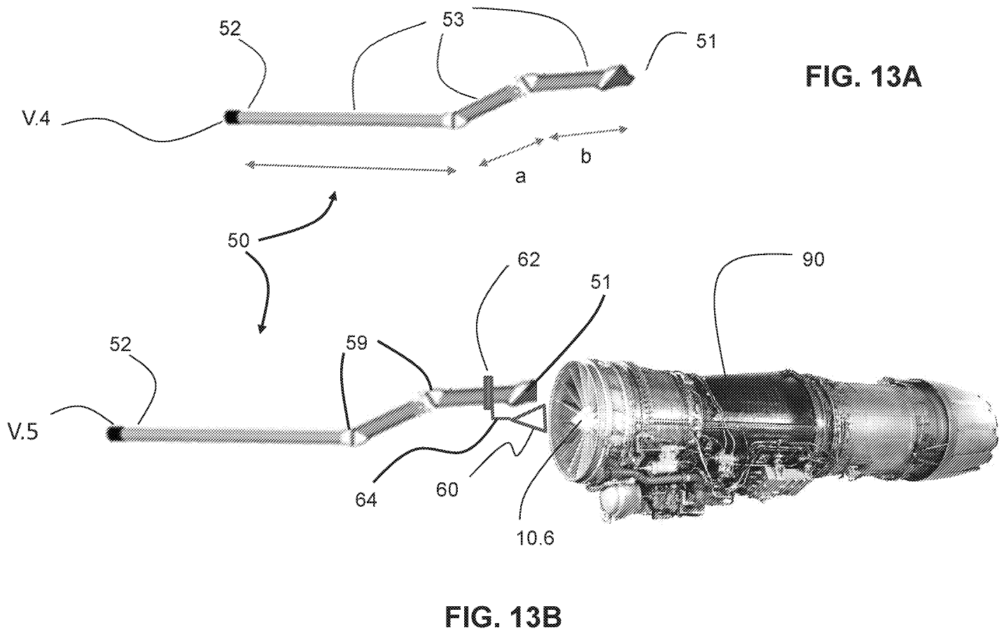

FIG. 13 shows versions V.4 and V.5 of spout assemblies according to other embodiments of the present invention. At the top of FIG. 13 is a spout assembly 50 labeled as “V.4.” It can be seen that in this version of the spout assembly there are three segments 53 providing a foam flowpath from an inlet at a quick connection 52, all the way to a foam delivery nozzle 51. In some embodiments, the first and last segments 53 are generally parallel, since the centerline of the face of the aircraft inlet and the centerline of the engine inlet may be parallel. A central segment 53a separates the two, providing an approximate S-shape. In some embodiments, the segments are separated by pivotal joints 59, which permit adjustable rotation of one segment relative to another. In still further embodiments, the three segments are attached together statically, such that relative rotation of one segment to another is not possible after the segments have been attached together. Still further embodiments contemplate four or more segments, so as to more accurately follow the centerline of the aircraft serpentine inlet, and/or to more accurately locate the foam delivery nozzle 51 to the desired location.

The bottom of FIG. 13 shows a spout assembly 50 referred to as “V.5” that is adapted and configured with a distalmost end that interfaces with, and positively locates relative to, the inlet face of an engine 90. Shown in this figure is a photographic representation of an F414 engine. Spout assembly 50 includes located proximate to its distalmost end a receptacle 60 having a generally conical shape. The conical shape of receptacle 60 is adapted and configured to positively locate on the bullet nose 10.6 of the engine. Receptacle 60 is attached to spout assembly 50 by means of a bracket 64. In some embodiments, this bracket further includes one or more outwardly extending legs. Such legs 64 (such as those shown in FIG. 1B) assist in locating of foam exit 51 to the proper location within a serpentine duct. These legs in some embodiments are flexible, and bend in reaction to a force that is about the same or slightly greater than the supported weight of the spout assembly. Still further, in some embodiments these legs include a rotating wheel or ball at the end so that any incidental contact with the inlet walls does not scratch any coating.

Preferably, spout assembly 50 includes attached proximate to the nozzle 51 one or more sensors 62. In one embodiment, a sensor 62 includes a borescope that permits visual sighting by the maintenance personnel of the distalmost end of the spout assembly as it is being moved through the serpentine inlet. In yet other embodiments, there can be sensors 62 that change capacitance, resistance, magnetic permeability, or other quality in the presence of the materials of the engine inlet face. Sensor 62 sends a signal (by wire along the length of the spout assembly, or wirelessly) to the maintenance personnel that use the signal to locate the nozzle 51 within the inlet 11.

While the inventions have been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

Various aspects of different embodiments of the present invention are expressed in paragraphs X1, X2, and X3 as follows:
X1. One aspect of the present invention pertains to a system for providing a gas-foamed liquid cleaning agent to a turbine engine. The system preferably includes a gas pump or reservoir of pressurized gas providing gas at a pressure higher than ambient pressure. The system preferably includes a liquid pump providing the liquid cleaner at a pressure. The system preferably includes a nucleation device receiving pressurized gas and pressurized liquid, and a foam outlet, the nucleation device turbulently mixing the pressurized gas and the pressurized liquid to create a foam. The system preferably includes a spout assembly having a supply section flowing the foam in a first direction toward a delivery nozzle, the nozzle flowing the foam in a second direction substantially opposite to the first direction, the nozzle being adapted and configured to deliver a low velocity stream of foam to the compressor inlet.
X2. Another aspect of the present invention pertain to a method for providing a gas-foamed liquid cleaning agent to a jet engine. The method preferably includes providing a source of a liquid cleaning agent, a liquid pump, a source of pressurized gas, a turbulent mixing chamber, and a flow-reversing spout assembly having a non-atomizing exit nozzle. The method preferably includes mixing pressurized gas with pressurized liquid in the mixing chamber and creating a supply of foam. The method preferably includes placing the spout assembly with the exit nozzle in front of the engine core. The method preferably includes streaming the supply of foam into the engine core from the nozzle.
X3. Yet another aspect of the present invention pertains to a system for providing a gas-foamed liquid cleaning agent to a turbine engine. The system preferably includes a source of gas at a pressure higher than ambient pressure. Some aspects include a source of gas other than air, and still further embodiments contemplate providing pressurized gas (including air) by any method, including by way of pressurized cylinders, or by way of a pressurized gas system that is present at the cleaning facility (such as a supply of “shop air”). The system preferably includes a nucleation device that creates a foam. The system preferably includes a spout assembly having a foam inlet for receiving foam from the nucleation device, a substantially rigid supply section flowing the foam from the foam inlet toward a foam delivery nozzle, the nozzle including a female receptacle adapted and configured to receive therein a complementary-shaped male feature of the engine, the nozzle being adapted and configured to deliver a low velocity stream of foam to the engine inlet. Alternatively, the spout assembly may include one or more locating struts adapted and configured to locate the foam nozzle centrally within the inlet, and proximate to the front face of the engine.

Yet other embodiments pertain to any of the previous statements X1, X2, or X3, which are combined with one or more of the following other aspects. It is also understood that any of the aforementioned X paragraphs include listings of individual features that can be combined with individual features of other X paragraphs.

Wherein the supply section is substantially rigid.

Wherein the supply section has a first length, the engine is located in a nacelle having a cowl, the cowl having a second length, and the first length is longer than the second length.

Wherein the nozzle is placed near the hub of the compressor.

Wherein the nozzle or receptacle is adapted and configured to fit between a pair of adjacent inlet guide vanes of the compressor.

Wherein the foam at the exit of the nucleation device has a cell structure, and the internal passageways of the spout assembly are adapted and configured to generally maintain the cell structure of the foam.

Wherein the pressure at the foam exit is less than about one hundred pounds per square inch.

Wherein the pressure at the foam exit is less than about fifty pounds per square inch.

Wherein the exit area of the nozzle is greater than about three fourths of a square inch.

Wherein the liquid cleaning agent is water soluble and the velocity of the foam exiting the delivery nozzle is less than about twenty feet per second.

Wherein the delivery nozzle is supported in an approximate J-shape and including a foam inlet linearly spaced apart from a hooked end having a foam exit.

Wherein the spout assembly includes a coupling in the supply section that can be articulated about at least one axis.

Which further comprises a frame having wheels, and the air pump, the liquid pump, and the nucleation device are attached to the frame.

Wherein the frame is part of a ground vehicle.

Wherein the frame is part of a ground cart having an electric motor to drive the liquid pump.

Wherein the spout assembly includes one or more sensors that provide a signal corresponding to the location of the distalmost end of the spout assembly relative to the front face of the engine. Such sensors can include a proximity sensor having resistance, capacitive, or other quality that changes in the presence of the front face of the engine. In still further embodiments the sensor can be an optical system, such as one having a lens providing an optical signal to a fiber optic cable, the optical signal being displayed visually to the maintenance personnel. One such example of an optical system is a borescope.

1-37. (canceled)

38. A method of cleaning a turbofan engine installed on an aircraft, the turbofan engine having a fan, a compressor, and a gas path, comprising
providing a non-atomizing foam discharge spout and an effluent collector;
creating a foam with a foaming system using a supply of pressurized gas, water, and cleaning chemicals;
placing the discharge spout in the gas path in front of the compressor and behind the fan;
injecting the foam from the discharge spout into the compressor of the turbofan engine;
cleaning contaminants in the gas path of the turbofan engine with the injected foam;
expelling the injected foam from the turbofan engine; and
collecting the expelled foam onto the effluent collector.

39. The method of claim 38 wherein the foam discharge spout includes an inlet for receiving the created foam and a hooked end having a non-atomizing nozzle.

40. The method of claim 39 wherein the gas path of the turbofan engine includes a splitter downstream of the fan, and the hooked end of the foam discharge spout couples to the splitter.

41. The method of claim 38 which further comprises rotating the turbofan engine during said injecting.

42. The method of claim 41 wherein said injecting the foam is into the compressor at a location such that the injected foam is lifted upward within the gas path.

43. The method of claim 38 wherein the turbofan engine includes a combustor and said cleaning includes cleaning of the combustor.

44. The method of claim 38 wherein the foam discharge spout has a hooked end.

45. The method of claim 44 wherein the foam discharge spout flows the created foam toward the hooked end in a first direction, and the hooked end flows the foam toward the compressor in a second direction substantially opposite of the first direction.
